(19) United States
(12) Patent Application Publication
(10) Pub. No.: US 2026/0161149 A1
(43) Pub. Date: Jun. 11, 2026

(54) METHOD AND DEVICE FOR WELDING CONDUCTOR ENDS

(71) Applicant: GROB-WERKE GmbH & Co. KG, MINDELHEIM (DE)

(72) Inventors: Valentin SCHMID, MINDELHEIM (DE); René SCHÜRER, MERING (DE)

(21) Appl. No.: 19/180,855

(22) Filed: Apr. 16, 2025

(30) Foreign Application Priority Data
May 17, 2024 (EP) 24176731.8

(51) Int. Cl. G05B 19/402; G01B 9/0209; G01B 11/00

(52) U.S. Cl. CPC G05B 19/402; G01B 9/0209; G01B 11/005; G05B 2219/45138

(57) ABSTRACT

A method for welding conductor ends arranged on a component in a conductor end arrangement, carried out during series production of a component of an electrical machine by: A) determining a position of predetermined conductor ends of the conductor end arrangement to be welded and B) arranging a welding device at the conductor ends based on the position determined in step A). Step A) includes performing a non-contact position detection to detect the position of the conductor end, and when the position has been detected, determining the detected position as the position for carrying out step B) and storing the detected position for the predetermined conductor ends, and when the position has not been detected, determining the position for carrying out step B) based on a position previously stored for the predetermined conductor ends to be welded.

### CROSS-REFERENCES TO RELATED APPLICATIONS

This application claims the benefit of European Patent Application Number 24176731.8 filed on May 17, 2024, the entire disclosure of which is incorporated herein by way of reference.

### FIELD OF THE INVENTION

The invention relates to a method to be carried out in the course of series production for a component of an electrical machine, for welding conductor ends that are arranged on the component in a conductor end arrangement. The invention further relates to a device for welding conductor ends in the course of series production for a component of an electrical machine, wherein the conductor ends are arranged on the component in a conductor end arrangement. The invention also relates to a control unit and a (control) computer program for such a device.

The methods and devices according to embodiments of the invention are intended in particular for use in the production of flat wire stators, especially hairpin stators. In hairpin stators, the coil winding is formed from a plurality of conductor sections bent in a hair-pin shape (called hairpins) which have two legs with free conductor ends that are connected to each other by a section bent in a roof-like manner. The hairpins are inserted into stator slots and then the coil winding is formed by welding the conductor ends, mostly in pairs. Embodiments of the invention relate to such welding of conductor ends and, in particular, to the detection of the conductor ends during the welding process.

### BACKGROUND OF THE INVENTION

For the technological background, reference is made to the following literature:
[1] EP 3 797 918 A1
[2] EP 3 865 242 B1
[3] EP 4 104 963 B1
[4] Wikipedia: Elektronenstrahl-Materialbearbeitung; downloaded on Apr. 26, 2024 under https://de.wikipedia.org/wiki/Elektronenstrahl-Materialbearbeitung
[5] WO 2019/161846 A1

From document [1], a method according to the generic part of claim 1 and a device according to the generic part of claim 10 are known. The documents [2] and [3] relate to comparable methods and devices. Reference [4] describes an electrode beam welding process that can be used as an alternative to the laser welding processes of documents [1] to [3], wherein an electrode beam can also be used for position determination.

### SUMMARY OF THE INVENTION

The invention is based on the problem of providing a method and a device that enable improved welding of the conductor ends in terms of reliability and less effort.

To address the aforementioned issues, the invention provides a method, a device, a control unit, and a computer program.

According to a first aspect, the invention provides a method to be carried out in the course of series production for a component of an electrical machine, for welding conductor ends that are disposed on the component in a conductor end arrangement, the method comprising:
A) determining a position of predetermined conductors of the conductor end arrangement to be welded and
B) arranging a welding means at the conductor ends to be welded, in dependence on the position determined in step a); wherein step A) comprises:
a) performing a non-contact position detection with the aim of detecting the position of the conductor ends of the conductor end arrangement to be welded,
b) if the position has been detected in step a), determining the detected position as the position for performing step B) and storing the detected position for the predetermined conductor ends; and
c) if the position has not been detected in step a), determining the position for performing step B) on the basis of at least one previously stored position for the predetermined conductor ends to be welded.

In some embodiments, step a) comprises the step of:
a1) performing an optical position detection.

In some embodiments, step a) comprises the step of:
a2) performing a camera-based position detection.

In some embodiments, step a) comprises the step of:
a3) recording an image of at least a sub-region of the conductor arrangement and performing image processing to detect the position of groups of conductor ends to be welded.

In some embodiments, step a) comprises the step of:
a4) performing a camera-based detection of the position of groups of conductor ends by means of edge detection based on contrast difference.

In some embodiments, step a) comprises the step of:
a5) recording a camera image and searching for a trained pattern, in particular based on contrast difference.

In some embodiments, step a) comprises the step of:
a6) performing an optical coherence tomography (OCT).

In some embodiments, step a) comprises the step of:
a7) detection by means of an electron beam.

In some embodiments, it is provided that step c) be performed instead of step b)
if no position was detected in step a) and/or
if a position detected in step a) is outside a predetermined tolerance range.

In some embodiments, step b) comprises the step of:
b1) storing the position correctly detected in step a) for each group of conductor ends of the component to be welded.

In some embodiments, step b) comprises the step of:
b2) storing the position detected in step a) for the predetermined group of conductor ends for each component of a component series.

In some embodiments, step b) comprises the step of:
b3) storing each coordinate of the position detected in step a).

In some embodiments, step b) comprises the step of:
b4) storing the position correctly detected in step a) for subsequent welding operations of further components of the same series.

In some embodiments, step c) comprises the step of:
c1) taking an average of positions stored during previous welding processes for welding the same conductor ends of the conductor end arrangement of other components of the same series.

In particular, the following step is carried out for this purpose:
c2) taking an average for each coordinate of the position from the coordinates previously stored for the predetermined conductor ends in other components of the same series.

In some embodiments, step c) comprises the step of:
c3) continuously taking an average of the position.

In an advantageous embodiment, each position newly detected and stored in step b) is incorporated in the averaging process (which is thus continuous). In some embodiments, an average is taken only once from an initial sample (e.g. the first 30 stators). Although this is less preferable because, for example, wear is not detected, it is certainly also a possible solution in view of the lower ongoing computing effort.

In some embodiments, the method further comprises the step of:
d) performing an optical presence check to determine whether the predetermined conductor ends to be welded are present.

In some embodiments, step d) is performed if the position is not detected in step a).

In some embodiments, step d) is performed before step c).

In some embodiments, step d) comprises:
detecting only one dimension of a group of conductor ends with conductor ends to be welded.

In some embodiments, step d) comprises:
detecting a cross-section of a visible surface of the conductor ends.

In some embodiments, step d) provides only YES or NO information.

In some embodiments, the method further comprises the step of: rejecting the component if it is determined in step d) that the conductor ends to be welded are not present.

Welding in step B) can be carried out using different welding methods, for example laser beam welding with a laser beam as a welding means (see [1] to [3]), electron beam welding with an electron beam as a welding means (see [4]) or other welding methods, e.g. with welding electrodes as a welding means, e.g., TIG welding.

Accordingly, in some embodiments, step B) comprises the step of:
B1) directing a welding beam, in particular a laser welding beam, onto the conductor ends to be welded, depending on the position determined in step a).

In some embodiments, step B) comprises the step of:
B2) directing an electron beam onto the conductor ends to be welded, depending on the position determined in step a).

In some embodiments, step B) comprises the step of:
B3) arranging at least one electrode for TIG welding at the conductor ends to be welded, depending on the position determined in step a).

According to a further aspect, the invention provides a device for welding conductor ends in the course of series production for a component of an electrical machine, the conductor ends being arranged on the component in a conductor end arrangement, the device comprising:
a position determination device for determining the position of predetermined conductor ends of the conductor end arrangement to be welded,
the position determination device comprising a non-contact detection device for detecting the position and a computer-implemented evaluation device, and
a welding device that is configured to arrange a welding means at the conductor ends to be welded, in dependence on the position determined by the position determination device;
wherein the evaluation device is configured to perform the following steps:
a) performing a non-contact position detection with the aim of detecting the position of the conductor ends of the conductor end arrangement to be welded,
b) if the position has been detected in step a), determining the position as the detected position and storing the detected position for the predetermined conductor ends; and
c) if the position has not been detected in step a), determining the position on the basis of at least one position previously stored for the predetermined conductor ends to be welded. In some embodiments, the non-contact detection device is configured to perform the step of:
a1) performing an optical position detection.

In some embodiments, the non-contact detection device is configured to perform the step of:
a2) performing a camera-based position detection.

In some embodiments, the non-contact detection device is configured to perform the step of:
a3) recording an image of at least a sub-region of the conductor arrangement and performing image processing to detect the position of groups of conductor ends to be welded.

In some embodiments, the non-contact detection device is configured to perform the step of:
a4) performing a camera-based detection of the position of groups of conductor ends by means of edge detection based on contrast difference.

In some embodiments, the non-contact detection device is configured to perform the step of:
a5) recording a camera image and searching for a trained pattern, in particular based on contrast difference.

In some embodiments, the non-contact detection device is configured to perform the step of:
a6) performing an optical coherence tomography (OCT).

In some embodiments, the non-contact detection device is configured to perform the step of:
a7) detection by means of an electron beam.

In some embodiments, the welding device comprises a laser device for directing a laser welding beam onto the conductor ends to be welded. In some embodiments, the welding device comprises an electron beam welding device for directing an electron beam onto the conductor ends to be welded. In some embodiments, the welding device comprises a TIG welding device that is computer-implemented to arrange at least one electrode at the conductor ends to be welded, depending on the position detection.

In preferred designs, the evaluation device is configured to perform the steps of the method according to any one of the above-described embodiments.

According to a further aspect, the invention provides a control unit for a device according to any one of the above-described embodiments, configured to control the device to perform the method according to any one of the above-described embodiments.

Preferably, the device according to any one of the above embodiments is provided with such a control unit.

According to a further aspect, the invention provides a computer program containing instructions that cause a device according to any one of the above-described embodiments to perform the method according to one of the above-mentioned configurations.

Some preferred embodiments of the invention relate to laser beam welding of hairpin wire ends based on mean pin coordinates of previous components after presence checking in the case of failed camera detection.

Some embodiments of methods and devices according to the invention relate to a detection of the position of the wire ends to be welded in the production of flat wire stators (hairpin stators). For example, embodiments of the methods and devices are used in a hairpin stator manufacturing process and in a hairpin stator manufacturing system, as described and shown in document [5].

In previous welding processes for welding conductor ends of stators or the like, the position of the conductor ends is detected, for example, in accordance with one of the solutions shown below:
camera-based detection by edge detection based on contrast difference and/or search for a trained pattern based on contrast difference;
optical coherence tomography (OCT); or
general omission of camera-based detection=positioning based on initially specified coordinates.

Camera-based detection, as described and shown in [1], for example, has proven effective. However, camera-based detection can have the following disadvantages:
none of the known techniques has a detection rate of 100%, meaning that certain cases cannot be detected;
known solutions must be adapted/re-trained when the surface properties/structure of the components to be detected change; and
sometimes there is a false positive detection (only supposedly correctly detected) due to allowing too large tolerances in order to achieve the highest possible detection rate

OCT methods have also proven useful. However, they can also have disadvantages such as a very high cycle time, since each connection must be detected individually (in contrast to a camera, which can capture several connections per image in the design according to [1]).

Some solutions completely do without the detection of the individual conductor ends. However, this solution also has some disadvantages:
when mechanical changes are made, the specified coordinates must be adjusted manually; and,
coordinates are either based on a one-time measurement (no consideration of the variation/no mean value) or the measurement effort increases with the number of measurements

In summary, the following challenges arise when welding the conductor ends of electrical components in a precisely positioned manner, in particular in the case of hairpin stators:
none of the known techniques achieves a 100% detection rate, certain cases cannot be detected;
known solutions must be adapted/re-trained when the surface properties/structure of the components to be detected change;
commissioning/maintenance effort increases with the detection rate to be achieved; and,
OCT requires a very high cycle time and is therefore only partially suitable for large quantity series systems.

Embodiments of the invention aim at improving high-precision welding of a large number of wire ends in the large-scale production of electrical components.

Particularly preferred embodiments additionally have one or more of the following objectives:
increase the detection rate->reduce scrap;
reduce maintenance;
reduce commissioning effort; and,
reduce false positive detections and the resulting scrap/damage to the tools.

Particularly preferred embodiments of the invention meet one, several or all of the following requirements:
appearance/surface of the wire ends to be detected varies greatly/can change over time->requirement: a presence-checking approach that covers all cases/projects (very difficult with previous solutions);
cycle time requirements;
commissioning and maintenance costs must be low; and,
ideally no additional costs for software/sensors.

The solution according to particularly preferred embodiments of the invention uses/expands the solutions already known (see [1] to [3]) by combining camera-based detection and positioning without detection. In some embodiments, the coordinates of detected components/wire ends are stored as “OK” and mean values are calculated for the respective positions. NOK detections (NOK=not in order) are automatically discarded. In some embodiments, in the event of a failed detection (camera/OCT/or detection with an electron beam during electron beam welding, see [4]), newly detected coordinates are not used and the welding process is positioned using the stored mean values (=blind welding). This way, a “detection rate” (welding rate) of 100% can be achieved. Optionally, a further presence check can be carried out after a detection failed and before blind welding. The presence check prevents the welding process from being triggered if not both conductor ends are present, thus avoiding possible damage to a clamping device (which is used in some designs to clamp the conductors). For this purpose, the existing non-contact detection system such as a camera system/OCT/electron beam scanning is used. Instead of a regular contrast-based edge detection which, for example, checks all four sides of a pin pair and thus both dimensions, some embodiments only check one dimension, e.g., the width of the pin pair, to ensure that both wire ends are present. Alternatively, it is possible to check only the cross-section of the visible cut surface or similar. This presence check is simpler than detection, since one dimension is omitted, for example, and a numerical value (position) needs not be provided, but only a YES/NO statement instead. This reduces the risk of a false positive evaluation and minimizes commissioning/maintenance effort. Even in the event of a false positive presence check, at least the placement of the welding would be correct, since this takes place on the basis of the mean values. In addition, several presence checks can be triggered one after the other until one approach provides proof of presence.

The cycle time of the overall system does not increase (without presence check) or only marginally (with presence check) compared to a classic camera-based detection, since blind welding is rarely used.

Preferred embodiments of the invention combine the best of both known approaches (detection or no detection at all): the accuracy of the positioning of the welding geometry is comparable to an approach in which welding takes place only after OK detection, since blind welding is only used in a few cases. Moreover, false positive detections also occur if welding only takes place after detection (especially in critical cases). In blind welding, this kind of incorrect positioning can be avoided by taking average values. This can even increase overall positioning accuracy, even though detection is partially omitted. Therefore, it makes sense to use blind welding in borderline cases rather than to force the presumptive detection by opening up the tolerances.

On the other hand, the previous approach of general abandonment of detection has the disadvantage that gradual changes in the pin positions over time or due to mechanical adjustments are not (automatically) taken into account and the welding quality decreases at some point. Adjusting the stored coordinates takes time and requires manual measurement/temporary integration of a camera/measurement system. This disadvantage is avoided by embodiments of the invention.

### BRIEF DESCRIPTION OF THE PREFERRED EMBODIMENTS

Exemplary embodiments are explained in more detail below with reference to the accompanying drawings, wherein it is shown by:

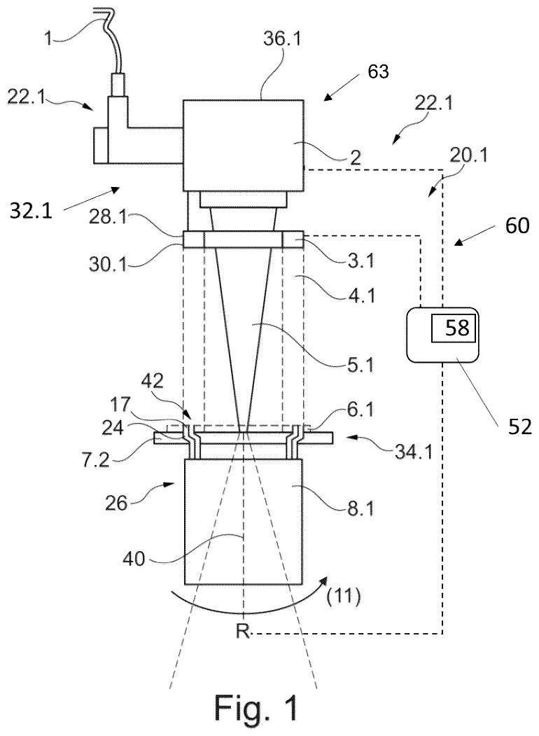

FIG. 1 a schematic representation of a first embodiment of a device for welding conductor ends;

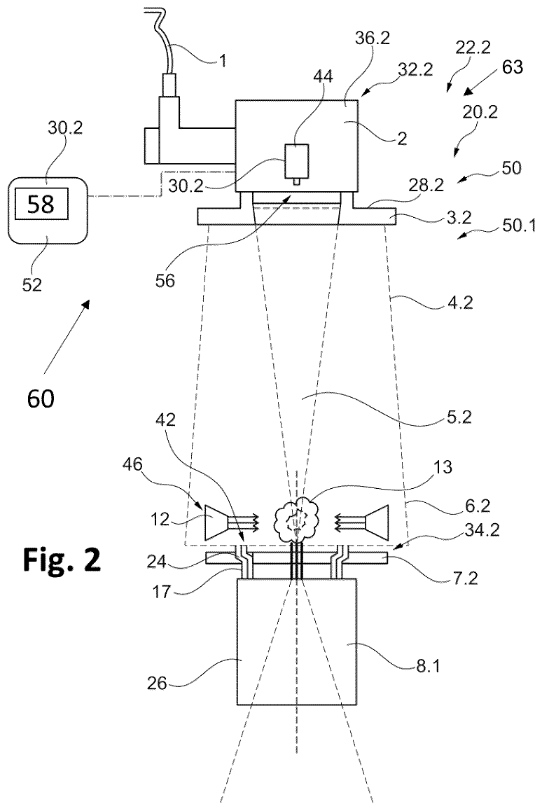

FIG. 2 a schematic representation of a second embodiment of a device for welding conductor ends;

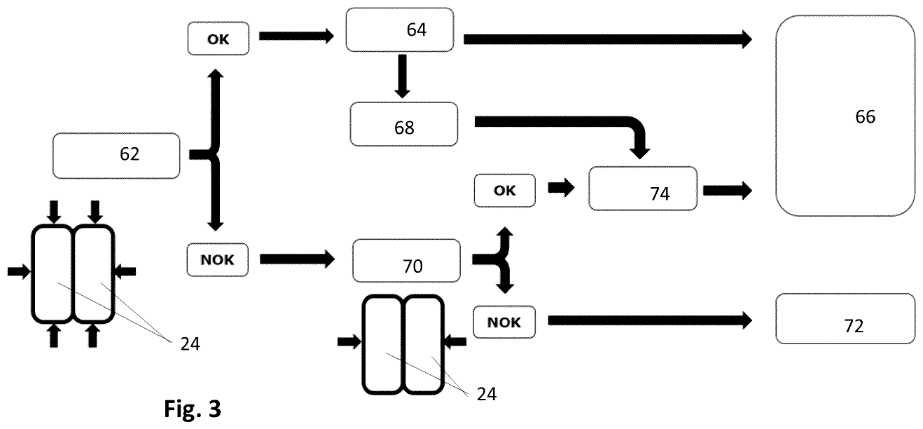

FIG. 3 a flow diagram of an embodiment of a method for welding conductor ends;

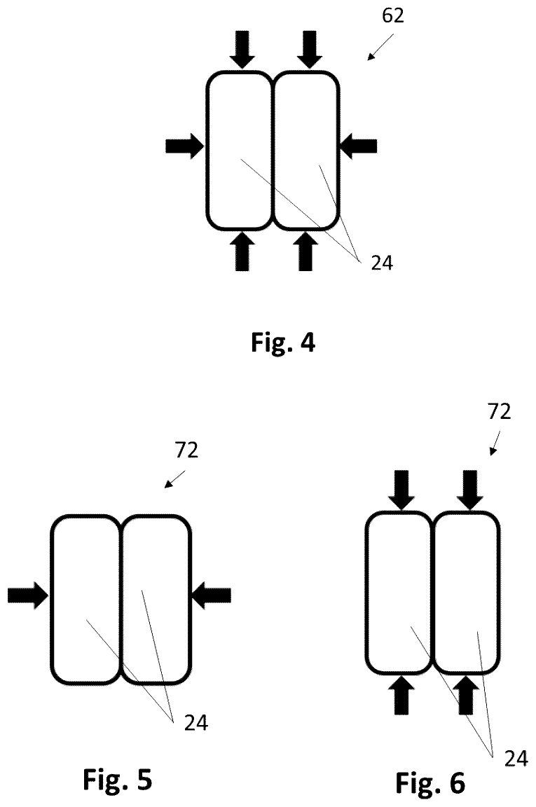

FIG. 4 a schematic representation of a pair of conductor ends in an embodiment of a non-contact position detection;

FIG. 5 a schematic representation of a pair of conductor ends in a first embodiment of an optional presence check in the method of FIG. 3; and

FIG. 6 a schematic representation of a pair of conductor ends in a second embodiment of an optional presence check in the method of FIG. 3.

### DETAILED DESCRIPTION OF THE PREFERRED EMBODIMENTS

In the following, embodiments of a device 22.1, 22.2 for welding conductor ends 24 in the course of series production for a component 26 of an electrical machine are explained with reference to FIGS. 1 and 2. The conductor ends 24 are arranged on the component 26 in a conductor end arrangement. The device 22.1, 22.2 has a position determination device 60 for determining the position of predetermined conductor ends 24 of the conductor end arrangement to be welded. The position determination device 60 comprises a non-contact detection device 30.1, 30.2 for detecting the position and a computer-implemented evaluation device 58. Furthermore, the device 22.1, 22.2 comprises a welding device 63 which is configured to arrange a welding means at the conductor ends 24 to be welded, depending on the position determined by the position determination device 60.

In the following, embodiments of the device 22.1, 22.2 are described in which the non-contact detection device 30.1, 30.2 is a camera-based optical detection device and in which the welding device 63 is a laser device 32.1, 32.2 which directs a laser beam 5.1, 5.2 as a welding means onto the conductor ends 24 to be welded. In other embodiments not shown here, the welding device 63 is designed as an electron beam welding device, where the non-contact detection device operates by means of electron beam scanning, see [4]. In other designs, the welding device 63 is a TIG welding device with electrodes that can be arranged at the conductor ends 24 to be welded by means of controlled movement mechanisms.

Two exemplary embodiments of a welding arrangement 20.1, 20.2. are illustrated in FIGS. 1 and 2.

The welding arrangement 20.1, 20.2 in each case comprises the device 22.1, 22.2 for welding conductor ends 24 that project from a component 26, as well as the component 26 to be processed.

In a preferred embodiment, the component 26 is a stator 8.1 of an electric motor to be used as a drive motor for motor vehicles. The stator 8.1 is manufactured according to a manufacturing process as described and shown in detail in document [5]. The devices 22.1, 22.2 described here are used to perform the welding process described in this document to connect conductor ends 24 that protrude from the stator 8.1, thus forming coil windings of the stator. The conductor ends 24 are in particular the free ends of hairpins 17 that have been inserted into grooves of a housing of the stator 8.1. Accordingly, the conductor ends 24 are also referred to as pins, and a pair of conductor ends 24 to be welded together is also referred to as a pin pair.

The device 22.1, 22.2 comprises an illumination device 28.1, 28.2, an optical detection device 30.1, 30.2, a laser device 32.1, 32.2 and a holder 34.1, 34.2.

The illumination device 28.1, 28.2 is used to illuminate the ends of the conductors 24. It may, for example, comprise a ring light 3.1 with a light cone 4.1 or a flat light 3.2 with a light cone 4.2.

In the illustrated embodiments, the non-contact detection device 30.1, 30.2 is designed as an optical detection device to detect conductor ends 24 illuminated by the illumination device 28.1, 28.2 in a conductor end arrangement 42 and to determine their position in a coordinate system. In some embodiments, an image evaluation on a camera image—camera 44—is provided for this purpose. Some embodiments use OCT for position detection. As already explained above, in other embodiments of the non-contact detection device 30.1, 30.2, scanning by means of an electron beam can also be performed for position detection.

In the illustrated embodiments, the laser device 32.1, 32.2 is designed to direct a laser beam 5.1, 5.2 onto the conductor ends 24, depending on the detected position, in order to perform the welding of the conductor ends 24. In some designs, laser light from a laser not shown is guided through an optical cable 1 to laser optics 2. The laser device 32.1, 32.2 has a scanning device 36.1, 36.2 for directing the laser beam 5.1, 5.2.

The holder 34.1, 34.2 is used to hold the component 26 and the conductor ends 24 during the welding process. For this purpose, the holder 34.1, 34.2 has a clamping device 7.2 as a welding template. The holder 34.1 can be movable relative to the welding device 63, for example by rotation about an axis 40 in a direction of rotation 11, in order to position welding means—i.e., a laser beam 5.1, 5.2, for example,—and conductor ends 24 relative to one another, or it can be stationary, in which case relative positioning is carried out solely by moving the welding means—e.g., directing the laser beam 5.2.

Furthermore, the device 22.1, 22.2 can comprise a flow generation device 46 for generating an air curtain 6.1, 6.2, for example with an air nozzle 12, to remove smoke residue 13.

The evaluation device 58 can be part of a computer-implemented control unit 52 of the device 22.1, 22.2, which has a processor and a memory in which at least one computer program for control and evaluation is stored. In particular, the computer program includes instructions that cause the device 22.1, 22.2 to perform a welding process, of which preferred embodiments are explained in more detail below with reference to FIG. 3. In some embodiments, the evaluation device 58 is configured to perform an image analysis of an image of the entire conductor arrangement 42 or a sub-region thereof, for example, to detect the positions of the individual conductor ends 24 to be welded, in particular individual pin pairs, by means of edge detection.

The welding process is carried out in the course of series production for a component of an electrical machine, such as in particular a hairpin stator 8.1, 8.2, in order to weld the conductor ends 24—ends of the hairpins 17—which are arranged on the component in a conductor arrangement 42. In particular, a large number of pairs of conductor ends have to be welded for hairpin stators in order to create the coil winding from individually inserted hairpins 17.

The welding method comprises the steps of:
A) determining a position of predetermined conductor ends 24 of the conductor end arrangement 42 to be welded, and
B) arranging a welding means at the conductor ends to be welded, depending on the position determined in step A).

Step A) of determining the position first comprises the step of:
a) performing a non-contact position detection with the aim of detecting the position of the conductor ends 24 of the conductor end arrangement 42 to be welded.

As can be seen from FIGS. 3 and 4, a detection 62 of the conductor ends 24 is carried out first. This takes place, for example, optically, e.g., using a camera 44 and image evaluation, e.g., edge detection. It is also possible to perform an optical coherence tomography (OCT). In particular, if an electron beam welding device is used, screening by means of the electron beam can take place to determine the position. FIG. 4 shows an example of a camera-based detection 62. In this case, an image is taken of the of the group of conductor ends or of the entire conductor end arrangement 42 or a sub-region thereof. In the evaluation unit 58, all outer edges are detected to determine the position of the respective conductor ends 24 to be welded in length and width. This provides coordinates for each pair of conductor ends (pin pair) to be welded.

Then a check is made to see whether the result of the detection 62 is “in order (OK)” or “not in order (NOK)”. The result of the detection 62 is in particular “not OK” if no position has been detected for the conductor ends 24 (e.g., for one of the plurality of pairs of conductor ends) or if a position detected for the respective conductor ends 24 is outside a predetermined tolerance range.

If the result of the detection 62 is “OK”, the pin pair coordinates 64 are used for welding 66. In addition, the pin pair coordinates are stored in a coordinate memory 68 for subsequent welding processes. This process is repeated each time each pair of conductor ends to be welded is correctly detected.

The coordinate memory 68 then stores the coordinates of correct detections from previous welding processes for previously processed components of the same series for each conductor end group to be welded (in particular for each conductor end pair).

If the result of the detection 62 is “not in order (NOK)”, an optional presence check 70 is carried out. This involves using a less elaborate detection process to check whether the pair of conductor ends whose position has not been correctly detected is actually present. If the result of the presence check 70 is “not correct (NOK)”, the component is rejected, e.g. as scrap 72.

FIGS. 5 and 6 show examples of the presence check 70. In the presence check 70, a similar detection is carried out as in the detection 62, but in a simpler form. In particular, the detection involves only one dimension, e.g., the width as shown in FIG. 5 or the length as shown in FIG. 6. Also, no quantitative detection is processed, a YES/NO answer is sufficient. For example, although a quantitative measurement is carried out in some embodiments to evaluate whether the measured dimension corresponds to the specified value plus tolerance, only a YES/NO answer is processed.

According to FIG. 3, to which reference is now again made, if the presence check is “OK” or if no presence check is provided, directly following an incorrect detection 62, averaging 74 is carried out, in which an average value of the respective coordinate from the coordinate memory 68 is taken. This average value is then used for the welding process for this pair of conductor ends instead of the coordinate the detection of which was not correct.

Accordingly, in embodiments of the welding process, Step A) comprises the steps of:
a) performing a non-contact position detection with the aim of detecting the position of the conductor ends 24 of the conductor end arrangement 42 to be welded,
b) if the position has been detected in step a), determining the detected position as the position for carrying out step B) and storing the detected position for the predetermined conductor ends 24; and
c) if the position has not been detected in step a), determining the position for performing step B) on the basis of at least one position previously stored for the predetermined conductor ends 24 to be welded.

In an advantageous embodiment, each new position detected and stored in step b) is included in the average calculation 74 (which is thus continuous).

In other embodiments, the average value is determined only once from an initial sample (e.g. the first 30 stators). The coordinate memory thus contains only the correctly detected positions of all conductor ends to be welded for an initial sample. Other averaging approaches are also possible, e.g., storage at every nth stator, storing only the last n stators (n=a natural number) in a shift register, etc.

In summary, in the illustrated embodiment of the welding process, the coordinates are stored as components/wire ends detected as “OK” and average values are calculated for the respective positions. NOK detections (NOK=not in order) are automatically discarded. In some embodiments, if a detection according to known solutions (camera/OCT/or detection with an electron beam in the case of electron beam welding, see [4]) fails, newly detected coordinates are not used and the welding process is positioned using the stored average values (=blind welding). This way, a “detection rate” (welding rate) of 100% can be achieved.

The method can be carried out using one of the devices 22.1, 22.2 as shown in FIG. 1 or 2, but also with other devices that detect positions and perform a welding operation based on the position detection. For this purpose, the evaluation of the position detection must be modified accordingly.

A method for welding conductor ends (24) arranged on a component in a conductor end arrangement (42) has been described, which method is to be performed in the course of series production for a component of an electrical machine and comprises the steps of:
A) determining a position of predetermined conductor ends (24) of the conductor end arrangement (42) to be welded, and
B) arranging a welding means at the conductor ends (24) to be welded, in dependence on the position determined in step A). In order to improve the welding method in terms of cost and accuracy, step A) is carried out with the steps of:
a) performing a non-contact position detection (62) with the aim of detecting the position of the conductor end (24) to be welded in the conductor end arrangement (42),
b) if the position has been detected in step a), determining the detected position (64) as the position for carrying out step B) and storing (68) the detected position for the predetermined conductor ends (24); and
c) if the position has not been detected in step a), determining the position for performing step B) on the basis of at least one position previously stored for the predetermined conductor ends (24) to be welded.

Furthermore, devices 22.1, 22.2, a control 52 and a computer program for performing the method have been described.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 optical cable
2 laser optics (scanner)
3.1 ring light
3.2 flat light
4.1 light cone of ring light
4.2 light cone of flat light
5.1 laser beam
5.2 laser beam
6.1 air curtain
6.2 air curtain
7.2 clamping device
8.1 stator
11 direction of rotation
12 air nozzle
13 smoke gas/smoke residue
17 hairpins
20.1 welding arrangement
20.2 welding arrangement
22.1 device
22.2 device
24 conductor ends
26 component
28.1 illumination device
28.2 illumination device
30.1 optical detection device
30.2 optical detection device
32.1 laser device
32.2 laser device
34.1 holder
34.2 holder
36.1 scanning device
36.2 scanning device
40 central axis
42 conductor end arrangement
44 camera
46 flow generation device
52 control unit
58 evaluation unit
60 position determination device
62 detection
64 pin pair coordinates
68 coordinate memory
70 presence check
72 scrap
74 averaging

Claimed is:

1. A method, carried out in during a series production of a component of an electrical machine, for welding conductor ends that are disposed on the component in a conductor end arrangement, the method comprising:
A) determining a position of predetermined conductor ends of the conductor end arrangement to be welded, and
B) arranging a welding means at the conductor ends to be welded, based on the position determined in step A);
wherein step A) comprises:
a) performing a non-contact position detection to detect the position of the conductor ends of the conductor end arrangement to be welded,
b) when the position has been detected in step a), determining a detected position as the position for performing step B) and storing the detected position for the predetermined conductor ends; and
c) when the position has not been detected in step a), determining the position for carrying out step B) with at least one position previously stored for the predetermined conductor ends to be welded.

2. The method according to claim 1, wherein step a) comprises at least one or more of the steps:
a1) performing an optical position detection;
a2) performing a camera-based position detection;
a3) recording an image of at least a sub-region of the conductor arrangement and carrying out image processing to determine a position of groups of conductor ends to be welded;
a4) carrying out a camera-based detection of a position of groups of conductor ends with an edge detection based on contrast difference;
a5) recording a camera image and searching for a trained pattern;
a6) performing an optical coherence tomography (OCT);
a7) detection by an electron beam; and,
any combination thereof.

3. The method according to claim 1, wherein step c) is performed instead of step b) when no position has been detected in step a), or when a position detected in step a) is outside a predetermined tolerance range, or both.

4. The method according to claim 1, wherein step b) comprises at least one or more of the steps:
b1) storing the position detected in step a) for each group of conductor ends of the component to be welded;
b2) storing the position detected in step a) for a predetermined group of conductor ends for each component of a component series;
b3) storing each coordinate of the position detected in step a);
b4) storing the position detected in step a) for subsequent welding processes of further components of the component series; and,
any combination thereof.

5. The method according to claim 1, wherein step c) comprises at least one or more of the steps:
c1) taking an average of positions stored during previous welding processes for welding conductor ends of other components of a series;
c2) taking an average for each coordinate of the position from coordinates previously stored for predetermined conductor ends of other components of the series;
c3) continuous averaging of the position; and,
any combination thereof.

6. The method according to claim 1, further comprising the step of:
d) performing a presence check to determine whether the predetermined conductor ends to be welded are present.

7. The method according to claim 6, wherein step d)
is performed when the position has not been detected in step a); or
is performed before step c); or
comprises detecting only one dimension of a group of conductor ends including conductor ends to be welded; or
comprises detecting a cross section of a visible surface of the conductor ends; or
provides only YES or NO information; or
any combination thereof.

8. The method according to claim 6, further comprising:
rejecting the component when it is determined in step d) that the conductor ends to be welded are not present.

9. The method according to claim 1, wherein that step B) comprises at least one of the following steps:
B1) directing a welding beam onto the conductor ends to be welded based on the position determined in step a);
B2) directing an electron beam onto the conductor ends to be welded based on the position determined in step a);
B3) arranging at least one electrode for TIG welding at the conductor ends to be welded based on the position determined in step a); and,
any combination thereof.

10. A device for welding conductor ends during a series production for a component of an electrical machine, the conductor ends being disposed on the component in a conductor end arrangement, the device comprising:
a position determination device for determining a position of predetermined conductor ends of the conductor end arrangement to be welded, the position determining device comprising a non-contact detection device for detecting the position and a computer-implemented evaluation device, and
a welding device configured to arrange a welding means at the conductor ends to be welded based on the position determined by the position determination device;
wherein the evaluation device is configured to carry out the following steps:
a) performing a non-contact position detection to detect the position of the conductor ends of the conductor end arrangement to be welded,
b) when the position has been detected in step a), determining the position as a detected position and storing the detected position for the predetermined conductor ends; and
c) when the position has not been detected in step a), determining the position based on at least one position previously stored for the predetermined conductor ends to be welded.

11. The device according to claim 10, wherein the non-contact detection device is configured to carry out at least one or more of the steps:
a1) performing an optical position detection;
a2) performing a camera-based position detection;
a3) recording an image of at least a sub-region of the conductor arrangement and carrying out image processing to detect a position of groups of conductor ends to be welded;
a4) performing a camera-based detection of a position of groups of conductor ends with edge detection based on contrast difference;
a5) recording a camera image and searching for a trained pattern;
a6) performing an optical coherence tomography (OCT);
a7) detecting with an electron beam; and,
any combination thereof.

12. The device according to claim 10, wherein the welding device is selected from a group consisting of: a laser device for directing a laser welding beam onto the conductor ends to be welded; an electron beam welding device for directing an electron beam onto the conductor ends to be welded; and a TIG welding device which is configured to arrange at least one electrode at the conductor ends to be welded.

13. A control unit for a device for welding conductor ends during a series production for a component of an electrical machine, the conductor ends being disposed on the component in a conductor end arrangement, the control unit configured to control the device to perform the method according to claim 1.

14. A non-transitory computer readable media storing a computer program comprising instructions that cause a device to perform the method according to claim 1 when executed by a processor.
